(19) United States
(12) Patent Application Publication
(10) Pub. No.: US 2010/0285381 A1
(43) Pub. Date: Nov. 11, 2010

(54) METHOD AND APPARATUS FOR OPERATING A FUEL CELL IN COMBINATION WITH AN ORC SYSTEM

(76) Inventors: Bruce P. Biederman, Old Greenwich, CT (US); Jarso Mulugeta, West Hartford, CT (US); Lili Zhang, West Hartford, CT (US); Frederick James Cogswell, Glastonbury, CT (US)

Correspondence Address: MARJAMA MULDOON BLASIAK & SULLIVAN LLP, 250 SOUTH CLINTON STREET, SUITE 300, SYRACUSE, NY, 13202, US

(21) Appl. No.: 12/740,469

(22) PCT Filed: Oct. 29, 2007
(86) PCT No.: PCT/US07/22810

§ 371 Date: Jul. 19, 2010

(51) Int. Cl. H01M 8/04

(52) U.S. Cl. 429/437

(57) ABSTRACT

An organic rankine cycle system is combined with a fuel system so as to use the waste heat from the fuel cell to both preheat and evaporate the working fluid in the organic rankine cycle system to thereby provide improved efficiencies in the system.

### TECHNICAL FIELD

This disclosure relates generally to fuel cell power plants and, more particularly, to a method and apparatus for using an ORC system in combination therewith.

### BACKGROUND OF THE DISCLOSURE

A fuel cell is an electrochemical cell which consumes fuel and an oxidant on a continuous basis to generate electrical energy. The fuel is consumed at an anode and the oxidant at a cathode. The anode and cathode are placed in electrochemical communication by an electrolyte. One typical fuel cell employs a phosphoric acid electrolyte. The phosphoric acid fuel cell uses air to provide oxygen as an oxidant to the cathode and uses a hydrogen rich stream to provide hydrogen as a fuel to the anode. After passing through the cell, the depleted air and fuel streams are vented from the system on a continuous basis.

A typical fuel cell power plant comprises one or more stacks of fuel cells, the cells within each stack being connected electrically in series to raise the voltage potential of the stack. A stack may be connected in parallel with other stacks to increase the current generating capability of the power plant. Depending upon the size of the power plant, a stack of fuel cells may comprise a half dozen cells or less, or as many as several hundred cells. Air and fuel are usually fed to the cells by one or more manifolds per stack.

In each of the fuel cells, waste heat is a by-product of the steam reforming process for conversion of fuel to a hydrogen rich steam, electrochemical reactions and the heat generation associated with current transport within the cell components. Accordingly, a cooling system must be provided for removing the waste heat from a stack of fuel cells so as to maintain the temperature of the cells at a uniform level which is consistent with the properties of the material used in the cells and the operating characteristics of the cells.

In the stack, where the chemical reactions take place, water is used to cool the stack and generate steam to be used in the furnace, where chemical reactions occur to generate hydrogen. The waste heat, which is at around 500° F. and includes water, exit air and depleted fuel, is directed to a waste heat recovery loop to provide the customer with low grade heat (i.e. up to 140° F.). The heat recovery loop often includes a condenser coupled with a glycol loop and a heat exchanger that couples the water system with the glycol loop. The customer can also get high grade heat (i.e. up to 250° F.) via the water which receives heat from the stack cooling loop. The heat exchangers that allow the customer to get the high and low grade heat are referred to as the customer water interface.

### DISCLOSURE

Briefly, in accordance with one aspect of the disclosure, an ORC (Organic Rankine Cycle) system is provided, with the ORC working fluid being circulated through the customer water interface in order to recover waste heat and generate additional electric power to thereby boost the system efficiency of the fuel cell.

In accordance with another aspect of the disclosure, a low grade heat exchanger is provided between the ORC system and the customer water interface to transfer heat from the customer water interface to preheat the working fluid of the ORC system.

In accordance with another aspect of the disclosure, a high grade heat exchanger is provided between the ORC system and the customer water interface to transfer high grade heat from the customer water interface to the working fluid of the ORC system.

In the drawings as hereinafter described, a preferred embodiment is depicted; however, various other modifications and alternate constructions can be made thereto without departing from the spirit and scope of the disclosure.

### BRIEF DESCRIPTION OF THE DRAWINGS

FIG. 1 is a schematic illustration of a fuel cell with the present disclosure incorporated therein.

FIG. 2 is a schematic illustration of the ORC portion thereof.

### DETAILED DESCRIPTION OF THE DISCLOSURE

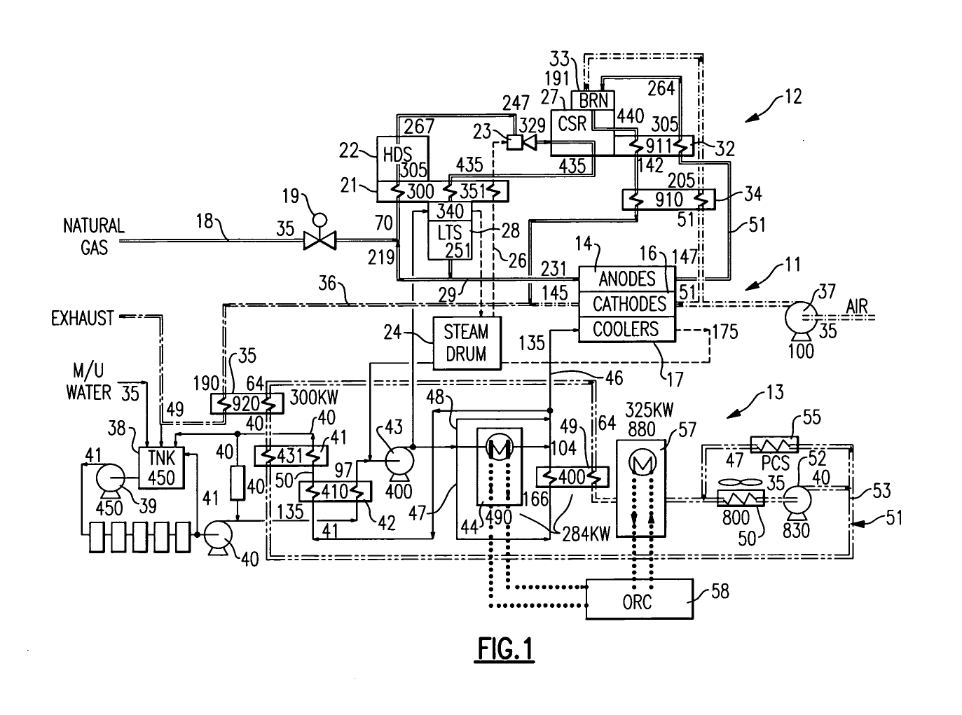

Shown in FIG. 1 is a phosphoric acid fuel cell system which generally includes a fuel cell stack 11, a fuel processing loop 12 and a waste heat processing loop 13. The fuel cell stack includes a plurality of electrochemical cells with each cell having an anode, a cathode, and a cooler for processing the waste heat that is generated from the cell. The collective anodes, cathodes and coolers for the plurality of cells in the stack are indicated at 14, 16 and 17, respectively.

Within the anodes 14, a supply of hydrogen is provided by the fuel processing loop 12 to fuel the chemical reactions within the anodes 14 in a manner to be described hereinafter. Similarly, within the cathodes 16, a supply of ambient air is provided as an oxide for fueling the chemical reaction within the cathode 16 in a manner to be described hereinafter. Finally, the coolers 17 are fluidly connected to the waste heat processing loop 13 to remove heat from the fuel cell stack 11 in a manner to be described hereinafter.

Referring first to the fuel processing loop 12 as shown by the double solid lines, the flow sequence along that loop will now be described, with the various typical temperatures, in degrees centigrade, being shown at the various locations indicated.

A supply of natural gas is provided along line 18 through valve 19 to a heat exchanger 21, where the temperature of the gas is raised from 70° C. to 303° C. The heated gas then flows to a hydro-desulphurizer 22 where the sulphur is removed from the natural gas. The gas then flows to an ejector 23 where it is mixed with steam from a steam drum 24 along line 26. The mixture then flows through the cell stack reformer 27 where the CH₄ (methane) and H₂O is reformed into CO₂ and H₂ and trace amounts of CO. The cell stack reformer 27 is heated by a burner 33 to cause an endothermic reaction to complete the reforming process. The reformed product then flows to the heat exchanger 21 where it gives up some heat and then enters the low temperature shift converter 28 where the CO is converted to H₂ and CO₂.

From the low temperature shift converter 28 the hydrogen gas passes to line 29 where it flows in both directions. That is, a portion of it flows to mix with the supply of natural gas and a portion of it flows to the anodes 14 to fuel the chemical reactions in the anodes 14. The resultant gas then leaves the anodes along line 31 to enter a heat exchanger 32, where it picks up heat and then flows to the burner 33. The exhaust gases then flow back through the heat exchanger 32 and through heat exchanger 34 prior to flowing into the line 36 of the waste heat processing loop. There it is mixed with heated air in a manner to be described, with the mixture flowing through heat exchanger 35 and then to ambient.

Turning now to the fuel for the cathodes 16, a compressor 37 provides compressed ambient air to the cathodes 16 for use of the oxygen therein as fuel for the chemical reactions in the cathodes 16. The waste gases then exit the cathodes 16 and pass to the line 36 where they are mixed with the exhaust gases from the burner 33 as described above. The flow of air is shown by the double dash-dot lines.

A portion of the compressed air from the compressor 37 is passed through the heat exchanger 34 to be heated and then passes to the burner 33 to be mixed with the gas from the anodes 14 for combustion within the burner 33.

Referring now to the waste heat processing loop 13, there is a water loop as shown by the single solid lines and a glycol loop as shown by the double long and two short dashed lines. A description will first be made of the water lines within the waste heat processing loop 13.

A supply of water stored in a tank 38 is pumped by pumps 39 and 40 to one side of a heat exchanger 42 where it picks up heat and is then mixed with a supply of hot water from the steam drum 24 prior to passing to a pump 43. The stream of hot water then flows to a high grade heat exchanger 44 for the transfer of heat in a manner to be described more fully hereinafter.

After passing through the heat exchanger 44, the water passes along line 46 to the coolers 17 where it is converted to steam which flows to the steam drum 24. A portion of the water passes from the pump 43 to the low temperature shift converter 28 where it is converted to steam which also passes to the steam drum 24.

A portion of the hot water from the pump 43 is also divided between lines 47 and 48, with the flow of line 47 going directly to the cooler 17 and the flow from line 48 passing through one side of a heat exchanger 49 prior to passing to the cooler 17. A portion of the water from line 46 passes through the other side of heat exchanger 42, through one side of heat exchanger 41 and then to the tank 38.

Also included as part of the waste heat processing loop 13 is the glycol loop 51 shown in double long and two short dashed lines. Circulation of the glycol within its loop is caused by the pump 52 which discharges to line 53 where it flows in two directions. A portion of the flow passes through a heat exchanger 55 in the power conditioning system (PCS) for cooling the PCS. It then passes through a fan cooled radiator 56 for the purpose of cooling the glycol and then back to the pump 52.

Another portion of the glycol passes through the other side of the heat exchanger 41, through the other side of the heat exchanger 35, and then through the other side of the heat exchanger 49. Finally, it passes through the heat exchanger 57 where the low grade heat is transferred from the glycol loop 51 to an ORC for pre-heating the working fluid of the ORC in a manner to be more fully described hereinafter.

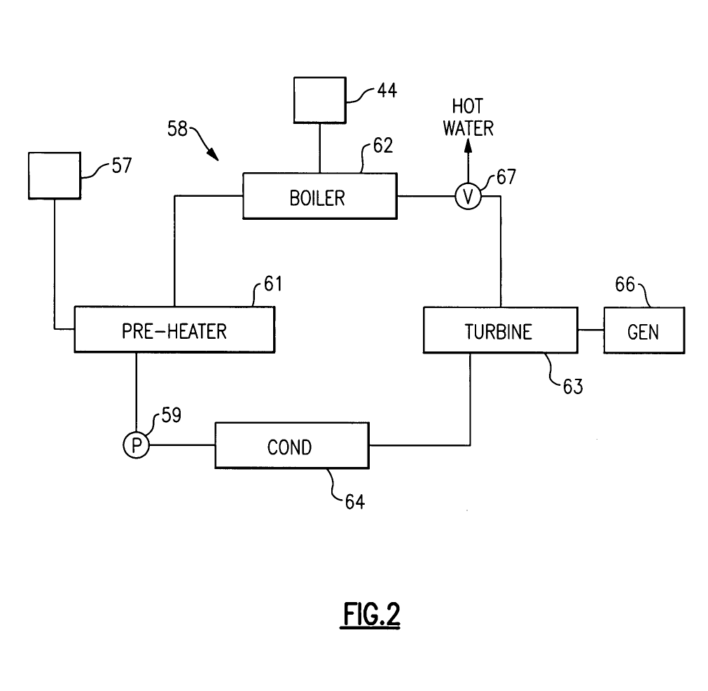

Referring now to FIG. 2, the ORC 58 is shown to include, in serial flow relationship, a pump 59, a preheater 61, a boiler 62, a turbine 63 and a condenser 64. The working fluid of the ORC can be any suitable refrigerant such as R-245fa or n-Pentane. The ORC turbine can be designed as, but is not limited to, a high speed direct drive turbine with magnetic bearings, and oil-less lubrication.

The heat exchanger 57 is fluidly and operationally connected to the preheater 61 to transfer low grade heat to preheat the working fluid of the ORC circuit. Similarly, the heat exchanger 44 is fluidly and operationally connected to the boiler 62 to transfer high grade heat to the boiler 62 for the purpose of vaporizing the working fluid within the ORC circuit 58. The turbine 66 can then be applied to drive a generator 66 for generating electricity. In this manner, waste heat from the fuel cell stack is converted to electrical energy by way of the ORC 58 which is integrated into the waste heat processing loop 13 by using low grade heat from the glycol loop 51 and high grade heat from the cooling water flowing through the system. Increased efficiencies are thus obtained for the system.

In the event that the customer wishes to have hot water, which has traditionally been available from the prior art systems, a valve 67 is provided downstream of the customer interface heat exchangers 57 and 44 so that hot water may be diverted from the turbine 63 on an as-needed basis.

It should be recognized that, in addition to the waste heat from the fuel cell system, waste heat from the power conditioning system 55, is also transferred first to the glycol loop 51 and then to the low grade heat exchanger 57.

The coupled fuel cells/ORC system can share a common dc bus, and or common grid protection parts to lower the cost of electrical components. They can also have separate inverters, if desired.

While the present disclosure has been particularly shown and described with reference to the preferred embodiment as illustrated in the drawings, it will be understood by one skilled in the art that various changes in detail may be effected therein without departing from the spirit and scope of the disclosure as defined by the claims.

We claim:

1. A fuel cell system having a fuel cell stack with a plurality of anodes, cathodes and coolers, a fuel processing loop and a waste heat processing loop wherein said waste heat processing loop comprises:
a first coolant loop which circulates a first fluid through said coolers to extract heat therefrom;
a second coolant loop which circulates a second fluid through said anodes to extract heat therefrom;
a third coolant loop which circulates a third fluid through at least one third coolant loop heat exchanger which is disposed within said third coolant loop and at least one of said first or second coolant loops to transfer heat to said third coolant loop;
an organic rankine cycle system having in serial flow relationship a pump, a boiler, a turbine and a condenser, with a fourth fluid being circulated therethrough as a working fluid; and
at least one ORC heat exchanger fluidly and operationally connected in at least one of said first or third coolant loops for transferring heat to said fourth fluid.

2. A fuel cell system as set forth in claim 1 wherein said at least one ORC heat exchanger comprises a pre-heater which transfers heat from said third coolant loop to said fourth fluid.

3. A fuel cell system as set forth in claim 2 wherein said heat transferred to said fourth fluid is low grade heat.

4. A fuel cell system as set forth in claim 1 wherein at least one ORC heat exchanger is disposed in said first coolant loop.

5. A fuel cell system as set forth in claim 4 wherein the heat transferred vaporizes the working fluid in the boiler.

6. A fuel cell system as set forth in claim 4 wherein said heat is high grade heat.

7. A fuel cell system as set forth in claim 1 wherein said at least one third coolant loop heat exchanger is disposed in said first coolant loop.

8. A fuel cell system as set forth in claim 7 wherein said heat is transferred from said third coolant loop to said first coolant loop.

9. A fuel cell system as set forth in claim 8 wherein said at least one third coolant loop heat exchanger comprises two heat exchangers.

10. A fuel cell system as set forth in claim 1 wherein said at least one third coolant loop heat exchanger is disposed within said second coolant loop.

11. A fuel cell system as set forth in claim 10 wherein said at least one third coolant loop heat exchanger transfer heat to said third coolant loop.

12. A fuel cell system as set forth in claim 1 and including a fifth circuit with a fifth fluid passing through the cathodes.

13. A fuel cell system as set forth in claim 12 wherein said fifth fluid comprises ambient air.

14. A fuel cell system as set forth in claim 12 wherein said fifth fluid, after passing through said cathodes, is combined with said second fluid.

15. A fuel cell system as set forth in claim 14 wherein said combined fluid is passed through said at least one third coolant loop heat exchanger.

16. A fuel cell system as set forth in claim 1 and including a power conditioning system for providing variable electrical power to said fuel cell system.

17. A fuel cell system as set forth in claim 16 and including a power conditioning system heat exchanger for transferring heat to said third coolant circuit.

18. A fuel cell system as set forth in claim 1 wherein said organic rankine cycle turbine is drivingly connected to a generator for generating electricity.

19. A method of using waste heat from a fuel cell system having a fuel cell stack with a plurality of anodes, cathodes and coolers, a fuel processing loop and a waste heat processing loop, comprising the steps of:
circulating a first fluid in a first coolant loop through said coolers to extract heat therefrom;
circulating a second fluid in a second coolant loop through said anodes to extract heat therefrom;
circulating a third fluid in a third coolant loop through at least one third coolant loop heat exchanger which is disposed within said third coolant loop and at least one of said first or second coolant loops to transfer heat to said third coolant loop;
providing an organic rankine cycle system having in serial flow relationship a pump, a boiler, a turbine and a condenser, with a fourth fluid being circulated therethrough as a working fluid; and
fluidly and operationally connecting at least one ORC heat exchanger in at least one of said first or third coolant loops for transferring heat to said fourth fluid.

20. A method as set forth claim 19 wherein said step of transferring heat to said fourth fluid with said at least one ORC heat exchanger comprises the step of transferring heat from said third coolant loop to said fourth fluid.

21. A method as set forth claim 20 wherein said heat transferred to said fourth fluid is low grade heat.

22. A method as set forth claim 19 wherein said step of transferring heat to said fourth fluid with said at least one ORC heat exchanger comprises the step of transferring heat from said first coolant loop to said fourth fluid.

23. A method as set forth claim 22 wherein said step of transferring heat to said fourth fluid with said at least one ORC heat exchanger comprises the step of vaporizing the working fluid in the boiler.

24. A method as set forth claim 22 wherein said heat is high grade heat.

25. A method as set forth claim 19 wherein said at least one third coolant loop heat exchanger is disposed in said first coolant loop.

26. A method as set forth claim 25 wherein said heat is transferred from said third coolant loop to said first coolant loop.

27. A method as set forth claim 25 wherein said at least one third coolant loop heat exchanger comprises two heat exchangers.

28. A method as set forth claim 19 wherein said at least one third coolant loop heat exchanger is disposed within said second coolant loop.

29. A method as set forth claim 28 wherein said at least one third coolant loop heat exchanger transfers heat to said third coolant loop.

30. A method as set forth claim 19 and including a fifth circuit with a firth fluid and including the stop of circulating said fifth fluid passing through the cathodes.

31. A method as set forth claim 30 wherein said fifth fluid comprises ambient air.

32. A method as set forth claim 30 wherein said fifth fluid, after passing through said cathodes, is combined with said second fluid.

33. A method as set forth claim 32 wherein said combined fluid is passed through said at least one third coolant loop heat exchanger.

34. A method as set forth claim 19 wherein said fuel cell system includes a power conditioning system and including the further step of providing variable electrical power from said power conditioning system to said fuel cell system.

35. A method as set forth claim 34 and including the step of transferring heat from said power conditioning system to said third coolant circuit.

36. A combination of an organic rankine cycle system of the type having a working fluid circulated therein and a fuel cell power plant of the type having a first coolant loop with a first fluid flowing therein, a second coolant loop with a second cooling fluid flowing therein, and with said second cooling fluid being passed in heat exchange relationship with a third circuit having a third fluid circulating therein, comprising:
at least one heat exchanger connected in heat transfer relationship between said third circuit and said organic rankine cycle system to transfer heat to said working fluid; and
a second heat exchanger connected in heat transfer relationship between said first circuit and said organic rankine cycle system to transfer heat to said working fluid.

37. A combined system of an ORC and a fuel cell power plant of the type having a primary coolant loop and a secondary coolant loop with a primary cooling loop having a first fluid and the secondary coolant loop having a second cooling fluid, with said second cooling fluid being passed in heat exchange relationship with a third circuit having a third fluid circulating therein, comprising:
a first heat exchanger connected in heat transfer relationship between said third circuit and said ORC circuit; and
a second heat exchanger connected in heat transfer relationship between said second circuit and said ORC circuit.
